(19) United States
(12) Patent Application Publication
(10) Pub. No.: US 2012/0296761 A1
(43) Pub. Date: Nov. 22, 2012

(54) SYSTEM AND METHOD FOR GROUP BIDDING ACCORDING TO AN OVERALL GROUP BID

(76) Inventor: Assaf MAYER YITZHAKI, Ramat Gan (IL)

(21) Appl. No.: 13/474,705

(22) Filed: May 17, 2012

Related U.S. Application Data
(60) Provisional application No. 61/488,233, filed on May 20, 2011.

(51) Int. Cl. G06Q 30/08

(52) U.S. Cl. 705/26.3

(57) ABSTRACT

A system and method for group bidding in which the supplier accepts or rejects the bids of the group as a group according to at least the overall group bid of the group, without being allowed to select or remove individual user bids, and optionally based upon one or more other characteristics of the group.

This Application claims priority from U.S. Provisional Application No. 61/488,233, filed on May 20 2011, which is hereby incorporated by reference as if fully set forth herein.

### FIELD OF THE INVENTION

The present invention is of a system and method for group purchases, and in particular but not exclusively, to such a system and method for group bidding in which a supplier accepts or rejects the bids of the group as a whole.

### BACKGROUND OF THE INVENTION

“Buying groups” or “purchasing groups” are known to exist offline; for example, a group of individuals may be able to negotiate a discount for an item, whether a product or a service. Various solutions have been proposed to extend the power of such groups on-line, through the Internet for example, where it would be easier and more efficient to connect and combine individuals to such a group. However, a number of these solutions give too much power to suppliers by allowing them to accept or reject the bids of individual buyers.

Such solutions are described for example in US Published Application No. 2010/0180232, in which individual buyers may be removed. Other solutions enable the group's offer to be accepted (or not) by the supplier, based upon a complicated set of parameters, as described for example in US Published Application No. 2008/0126215.

### SUMMARY OF AT LEAST SOME ASPECTS OF THE INVENTION

The present invention, in at least some embodiments, provides a system and method which overcomes the drawbacks of the background art for group bidding in which a supplier accepts or rejects the bids of the group as a whole according to at least the overall group bid of the group, without being allowed to select or remove individual user bids, and optionally based upon one or more other characteristics of the group. As noted in greater detail below, a supplier is not permitted to remove one or more users from the group but instead accepts or rejects the bid of the group according to the overall group bid, such as a group average bid for example. However, the supplier is optionally permitted to make a counter offer with regard to the overall group bid, which has the effect of increasing reimbursement to the supplier, for example by increasing the overall group bid, such as for example by increasing the group average bid. To do so, the supplier would effectively cut a portion of the group with a bid that is too low for the counter offer bid; however users would then have the option to increase their offer and hence to rejoin the buying group.

According to at least some embodiments of the present invention, there is provided a method for group bidding and purchase for an item by a buying group, the group comprising a plurality of users communicating through a plurality of user computers, the method comprising: receiving a plurality of bids from the plurality of users through the plurality of user computers by a computational entity; calculating an overall group bid of said plurality of bids by said computational entity; determining a minimum bid according to a distance from said overall group bid by said computational entity; and for purchasing users having bids above said minimum bid, purchasing the item by said purchasing users according to each bid of each user, such that there is a distribution of different payments by said purchasing users according to a distribution of different bids above said minimum bid.

Optionally the computational entity comprises a central server.

Optionally the computational entity comprises the plurality of user computers and wherein said calculations are distributed over the plurality of user computers.

Optionally purchasing the item further comprises recalculating an overall group bid according to bids above said minimum bid; offering said overall group bid to at least one supplier; and accepting said overall group bid by an accepting supplier, such that said accepting supplier supplies the item to said purchasing users.

Optionally determining said minimum bid further comprises offering said overall group bid to at least one supplier; indicating an acceptable overall group bid by said at least one supplier; accepting a supplier offered overall group bid, wherein said minimum bid is calculated according to said supplier offered overall group bid.

Optionally determining said minimum bid further comprises offering said overall group bid to at least one supplier; receiving either acceptance of said overall group bid or a counter-offer from said at least one supplier if said overall group bid is not accepted, accepting a qualifying counter-offer bid from a supplier or more, wherein said minimum bid is calculated according to said qualifying counter-offer bid.

Optionally the method further comprises before said purchasing the item by said purchasing users, setting a time period during which user bids are accepted; rejecting user bids after said time period has expired; and requiring users having bids above said minimum bid to purchase the item after said time period has expired.

Optionally the method further comprises while said time period has not expired, receiving a new bid from a user; and displaying to the user an indication of a likelihood of success of said new bid, according to a comparison of said new bid to said overall group bid.

Optionally determining said minimum bid according to said distance from said overall group bid further comprises analyzing bids from the users to determine a distance of each bid from said overall group bid; accepting bids above said overall group bid; and accepting a low bid below said overall group bid if said low bid is not lower than a predefined distance from said overall group bid.

Optionally distance is determined according to one or more standard deviations from said overall group bid.

Optionally the method further comprises analyzing a plurality of successful bidding and purchasing processes for a plurality of items to determine a likely successful distance from said overall group bid.

Optionally the plurality of items fall into a single item category and wherein said analyzing is performing for a plurality of item categories.

Optionally the method further comprises while said time period has not expired, receiving a new bid from a user; and displaying to the user an indication of a likelihood of success of said new bid, according to a comparison of said new bid to said overall group bid with said likely successful distance from said overall group bid.

Optionally the method further comprises before said receiving said plurality of bids from the users, starting the group according to a request from a user.

Optionally the request from said user is received through a user computer by indicating an item of interest for purchase by said user to said computational entity.

Optionally indicating said item of interest is performed by the user according to a software interface installed on said user computer.

Optionally during a time period for accepting bids, said receiving said plurality of bids further comprises joining the group by said plurality of users.

Optionally each of said plurality of bids includes a purchase price of the item and a geographical cost.

Optionally the geographical cost is limited to a maximum percentage of said purchase price.

Optionally each of said plurality of bids only includes a purchase price of the item and wherein a geographical cost is borne by said supplier.

Optionally said geographical cost comprises one or more of a delivery cost and a tax cost.

Optionally each of said supplier and said user pays for one of said delivery cost and said tax cost.

Optionally the item comprises a product.

Optionally the item comprises a service.

Optionally the method further comprises providing a social network for supporting communication between the users and said computational entity.

Optionally the method further comprises splitting the group into a plurality of buying groups according to one or more of a number of users in the group and an overall group bid of each of said plurality of buying groups.

Optionally splitting the group further comprises rejecting the overall group bid of the group by a supplier; providing a counter offer of an adjusted overall group bid by the supplier; calculating a division of the group according to said adjusted overall group bid to a portion of the group that is maintained and a portion of the group that is rejected.

Optionally the method further comprises offering a possibility of adjusting a bid by the one or more users in the portion of the rejected group.

Optionally adjusting said bid comprises increasing said bid by the one or more users in the portion of the rejected group to at least said adjusted overall group bid.

Optionally the method further comprises before said receiving said plurality of bids from the users, starting the group according to a request from a supplier.

Optionally the method further comprises before said receiving said plurality of bids from the users, receiving a request from a user and a request from a supplier; and matching said user and supplier by forming a buying group.

Optionally the method further comprises calculating said overall group bid according to a calculation selected from the group consisting of an average of the plurality of user bids and a median of the plurality of user bids.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1D show different exemplary non-limiting embodiments of a system according to the present invention;

FIG. 2 is a flowchart of an exemplary, illustrative method according to at least some embodiments of the present invention for an exemplary bidding process;

FIG. 3 is a flowchart of an exemplary, illustrative method according to at least some embodiments of the present invention for an exemplary bidding process with regard to the supplier(s);

FIG. 4 is a flowchart of an exemplary, illustrative method according to at least some embodiments of the present invention for analysis of historical bidding processes; and

FIGS. 5A and 5B relate to flowcharts of exemplary, illustrative methods according to at least some embodiments of the present invention for an exemplary bidding process with regard to the users (FIG. 5A) or the supplier(s) (FIG. 5B).

### DESCRIPTION OF THE PREFERRED EMBODIMENTS

The present invention is, in at least some embodiments, of a system and method for group bidding in which a supplier accepts or rejects the bids of the group as a whole according to at least the overall group bid of the group, without being allowed to select or remove individual user bids, and optionally based upon one or more other characteristics of the group

With regard to the description of the drawings, it should be noted that the term “group average bid” is used to describe a non-limiting example of an overall group bid. Other non-limiting examples include a median bid of the user bids and any other statistical analysis relating to an overall determination of a group bid from a plurality of user bids.

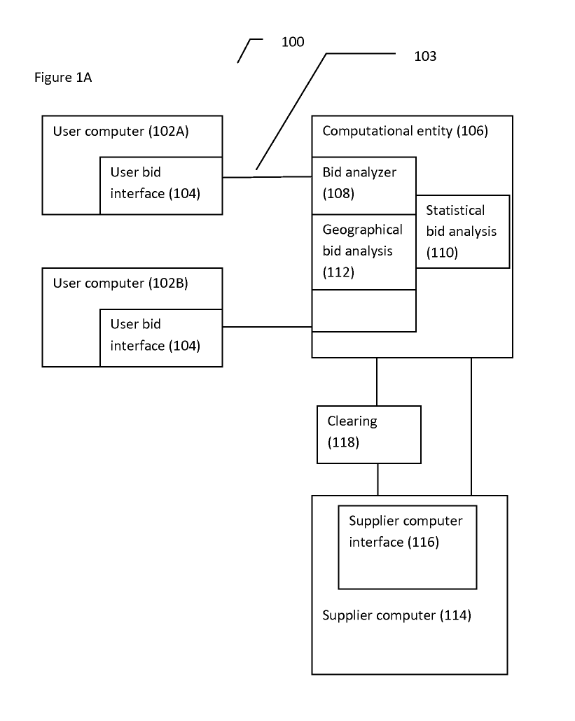

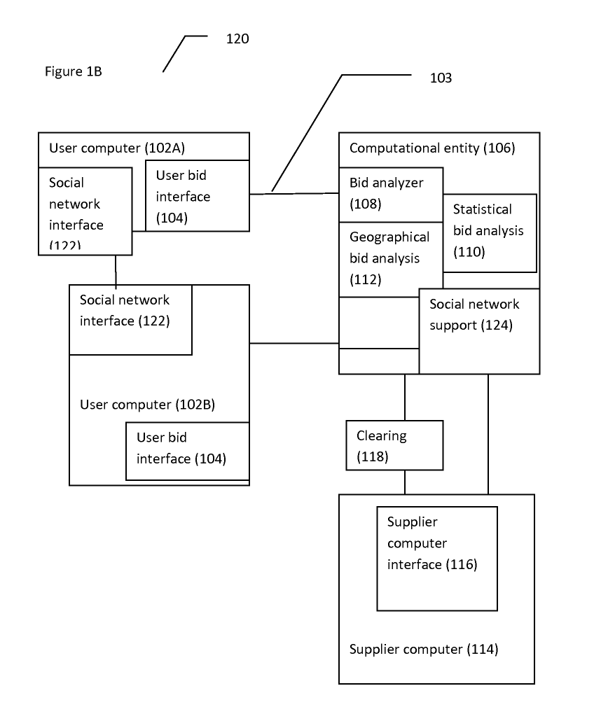

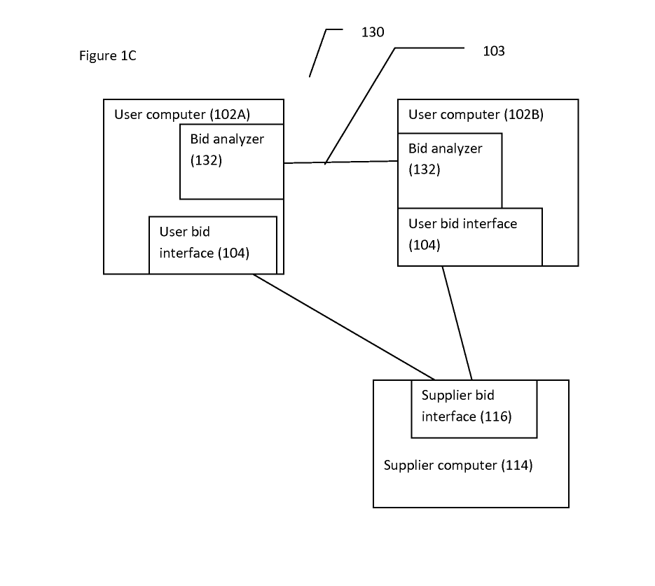

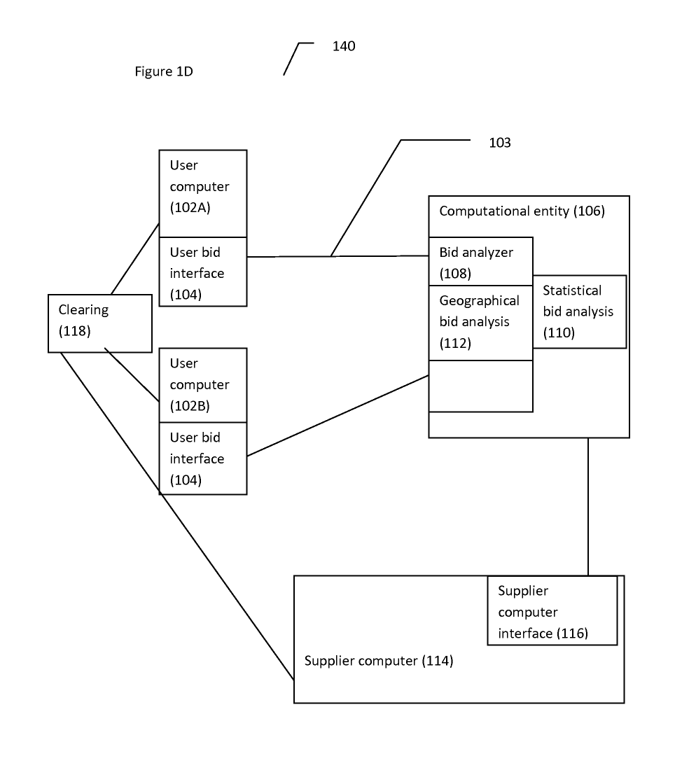

Referring now to the drawings, FIGS. 1A to 1D show different exemplary non-limiting embodiments of a system according to the present invention, for receiving, analyzing and accepting/rejecting group bids for a plurality of users in a group. Components labeled with the same reference number have the same or similar function throughout FIGS. 1A-1D.

Turning now to FIG. 1A, a system 100 features a plurality of user computers 102, of which two are shown for the purpose of illustration only and without wishing to be limiting in any way, user computer 102A and user computer 102B. Each user computer 102 communicates through a network 103, which may optionally be the Internet or any other type of computer network, with a computational entity 106. User computers 102 communicate with computational entity 106 for participating in a group bid, in which each user operating user computer 102 is indicated as at least a potential participant in a group bid for an item, which may optionally be a product or service. Computational entity 106, in this non-limiting embodiment, handles the central processing and analysis for the group bids, and also provides central support for the bidding process. Computational entity 106 may optionally comprise a central server or a plurality of servers in any suitable configuration (for example and without limitation, as a server farm or any other distributed computing system).

To facilitate communication between user computers 102 and computational entity 106, each user computer 102 preferably features a user bid interface 104, for communicating with a bid analyzer 108 of computational entity 106. Each user may optionally enter a bid and also may optionally and preferably receive information regarding the bid (for example, whether the bid was successful) through user bid interface 104. Optionally the user may also view the item through user bid interface 104, for example an image of the item if a product and/or a description of the item (whether a product or a service). User bid interface 104 may optionally be implemented as a plug-in or other additional software to an existing software being operated by user computer 102, such as a web browser as a non-limiting example. It should be noted that optionally the display of the product is performed through a separate software or display than user bid interface 104.

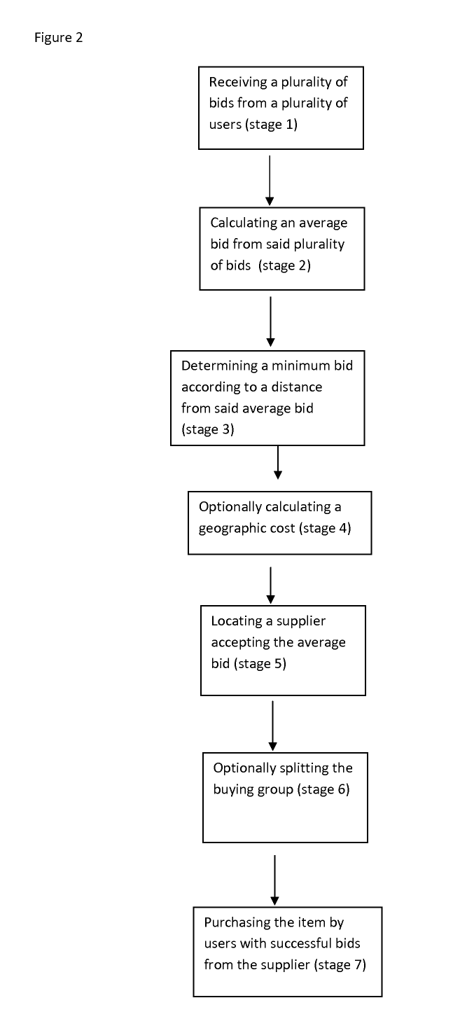

Bids entered through user bid interface 104 are received by bid analyzer 108 of computational entity 106, which then analyzes these bids. Preferably the bids are analyzed to determine a group average bid; optionally bid analyzer 108 also determines one or more characteristics of the group. For example and without limitation, geographical distribution and/or any other geographical aspects for purchases by users in the group, for example and without limitation any taxes that must be paid upon a sale. Such geographical aspects optionally and preferably are determine with regard at least to delivery address but may also optionally be determined with regard to payment address if required. Such geographical aspects may optionally be analyzed by a geographical bid analysis module 112 as described in greater detail below with regard to FIG. 2 below.

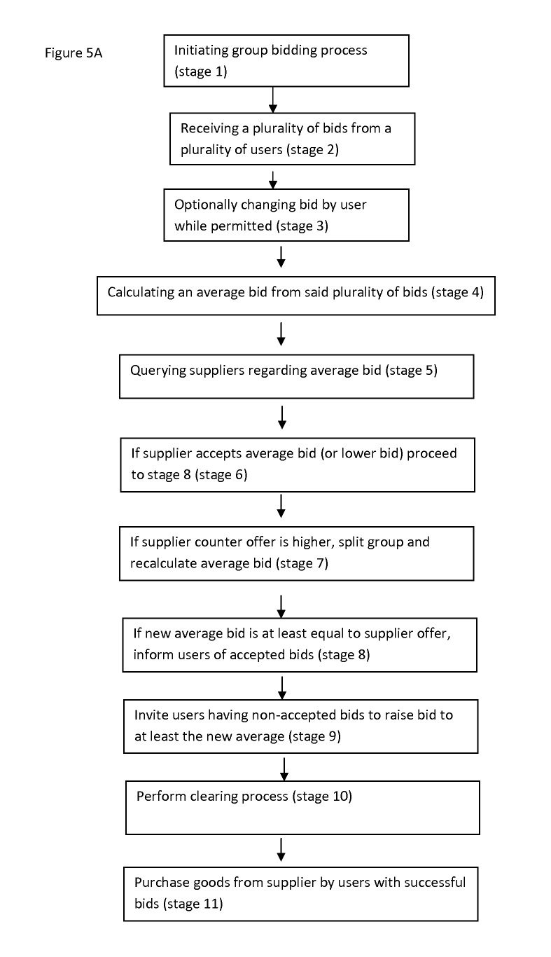

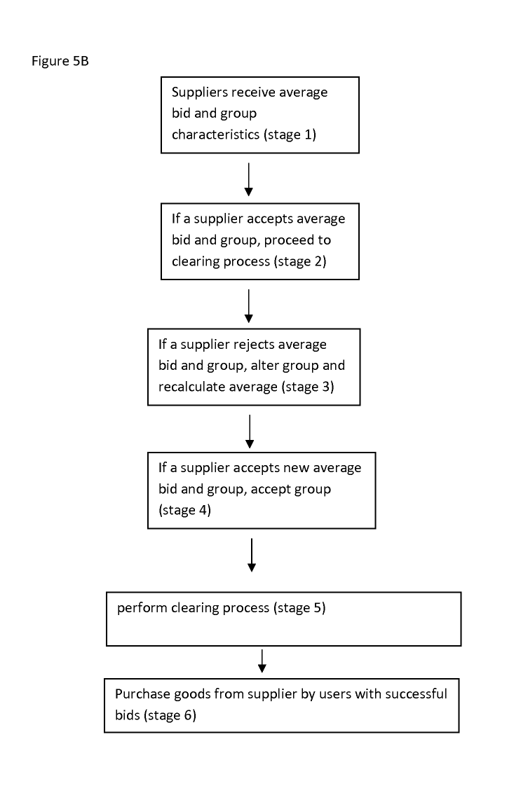

Bid analyzer 108 also optionally and preferably performs statistical analysis of the characteristics of the bids of the users in the group in conjunction with a statistical bid analysis module 110, for communicating with a supplier computer 114 through a supplier computer interface 116. As described in greater detail below with regard to the method of FIG. 2, optionally such communication at least includes information regarding the average group bid; it may also optionally include the above described geographical characteristics of the users in the group. However, as described in greater detail with regard to the method of FIG. 5, if the group average bid is rejected by the supplier, optionally the statistical analysis of statistical bid analysis module 110 may also relate to dividing or otherwise modifying the group, in order to determine whether the supplier operating supplier computer 114 will accept the modified group and hence the modified average group bid.

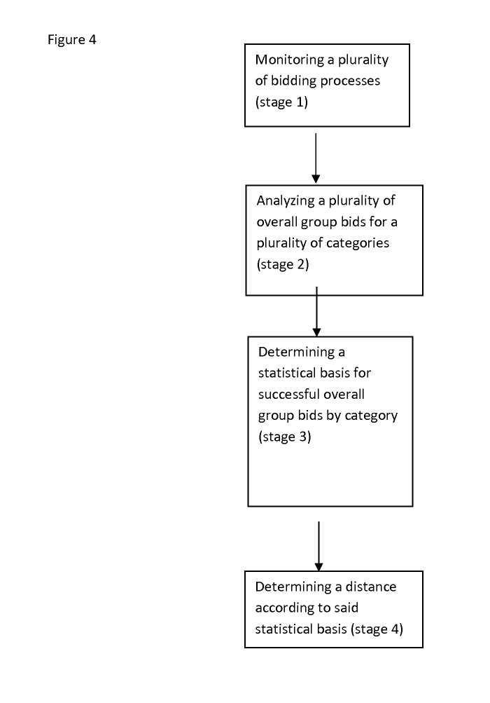

Additionally or alternatively, statistical bid analysis module 110 may also optionally perform statistical analysis with regard to previously accepted group bids, in order to predict the likelihood of a group average bid being accepted according to historical trends of such acceptance, as described in greater detail with regard to the method of FIG. 4 below.

As previously noted, the group average bid may optionally be accepted or rejected by a supplier; however the supplier is not able to reject individual bids but rather may only accept or reject the group as a whole, based (in this non-limiting example) upon the group average bid. Optionally the supplier is able to submit a new proposed price and ask how many users would remain in the group with that new price.

If the group average bid (and optionally also the group) is accepted by the supplier operating supplier computer 114, then payment is made by the users, preferably through user computer 102, and is then optionally and preferably processed by a clearing mechanism 118. Clearing mechanism 118 may optionally be operated in a number of different ways. For example, the user may optionally provide payment details to computational entity 106 as shown, after which computational entity 106 may optionally perform the clearing mechanism (in which case clearing mechanism 118 is preferably a part of or at least is in direct communication with computational entity 106). Alternatively, clearing mechanism 118 may be related to the supplier, in which case clearing mechanism 118 is preferably in contact with or is a part of supplier computer 114. As yet another alternative, clearing mechanism 118 may belong to a third party, which is neither computational entity 106 or the supplier. In FIGS. 1A and 1B, computational entity 106 receives payment from the users, preferably through communication through user computers 102, and passes it on to clearing mechanism 118. In FIG. 1D, computational entity 106 does not receive payment and instead the users pay clearing mechanism 118 directly.

Once payment has been made, or according to other terms between the supplier and the users, then the item is provided to the user; for example, if a physical product, then the item is shipped to a physical address designated by the user.

The supplier may also optionally make a counter offer as described in greater detail below, if the supplier wishes to reject the overall group bid.

FIG. 1B shows a similar system to that of FIG. 1A; however, in a system 120, social network components are featured in order to connect users to each other socially but also to increase communication regarding user bids; for example, the social network components may optionally be used to invite one or more users through user computers 102 to join a group.

These social network components optionally and preferably include a social network interface 122, operated by user computer 102; and a social network support module 124, operated by computational entity 106. Optionally the social network components may be part of an existing social network as is known in the art, including but not limited to Facebook, LinkedIn and the like; alternatively, the social network components may optionally be entirely supported through social network support module 124 of computational entity 106, rather than being part of an existing social network. By “social network” it is meant that users are preferably aggregated into a buying group through the social network, even if (for example) the users are being aggregated through different social network components and/or through different websites. For example, users may optionally be aggregated by indicating a desire to purchase a product, regardless of how the users are able to convey this information.

FIG. 1C shows a different embodiment of a different system 130, which lacks a centralized computational entity. Instead system 130 is implemented with regard to distributed computing. Each user computer 102 not only operates user bid interface 104 but also preferably operates a bid analyzer 132. Bid analyzers 132 of user computers 102 communicate with each other through network 103 as shown, and perform the bid analysis functions described with regard to the computational entity of FIGS. 1A and 1B. The clearing mechanism is not shown for clarity but may optionally be implemented according to any of the embodiments described herein.

FIG. 1D shows yet another different embodiment of a different system 140, in which clearing mechanism 118 communicates directly with user computers 102; computational entity 106 may not be involved in collecting payment and/or payment information from user computers 102.

FIG. 2 is a flowchart of an exemplary, illustrative method according to at least some embodiments of the present invention for an exemplary bidding process with regard to the group. The method may optionally be implemented through any of the systems of FIGS. 1A-1D. As shown, in stage 1 a plurality of bids are received from a plurality of users, preferably through user computers as previously described. The plurality of users form the group for bidding; as described in greater detail with regard to FIG. 5 below, the users may optionally indicate a desire to join the group according to information provided and/or may optionally be invited to join the group.

In stage 2, the plurality of bids is used to calculate a group average bid as a non- limiting example of an overall group bid. The calculation is optionally and preferably performed by a computational entity, which may optionally be a central computational entity (as in the systems of FIGS. 1A, 1B and 1D) or alternatively may optionally be embodied through distributed computing, as in FIG. 1C, in which the operation of the plurality of user computers supports the calculations and hence forms the computational entity.

In stage 3, a minimum bid is preferably determined according to a distance from the group average bid. By “distance” it is preferably meant an extent to which the minimum bid is considered to be sufficiently high to be acceptable, for example optionally by a supplier. The distance is preferably a statistical measure which is used to determine the average of the group bids above the minimum bid and hence which bids are successful (acceptable).

In stage 4, a geographical cost is optionally calculated. The geographical cost may optionally relate to one or more of geographical locations of physical addresses for delivery of a product (if applicable), tax regimes within a geographical area (whether for delivery, for payment (ie location of the user) or a combination thereof), customs (for shipments between countries) and so forth. If calculated, the geographical cost is optionally added to the group average bid. Alternatively, the user may be informed of the cost and required to pay all or part of it; if the user is only required to pay part, then the remainder is preferably added to the group average bid or alternatively is optionally provided as an addition above the group average bid and separate from it.

In stage 5, a supplier is located which accepts the group average bid. Such a supplier may optionally be located through providing the group average bid (and optionally also one or more characteristics of the group, for example relating to the geographical cost) to a plurality of suppliers. A supplier of the plurality of suppliers may optionally agree to accept the bid. Alternatively or additionally, one or more suppliers could provide details of an average group bid which would be acceptable for a particular item; once a matching average group bid is found (from a plurality of users) then the group of users would be matched with the supplier which previously indicated that this average group bid would be acceptable. However, preferably the supplier is only able to accept or reject the group as a whole with regard to the overall group bid, and is not able to eliminate one or more users (i.e.—is not able to eliminate one or more bids) from the group.

In stage 6, the buying group of users is optionally split. For example, the group of users may optionally be split as described with regard to FIG. 5, in order for a portion of the group of users to provide a successful group average bid. However again as noted above, preferably the supplier is not able to remove one or more users from the group; instead the supplier may relate to portions of the group in terms of statistical analysis (ie distance from the average bid) in order to make a counter offer which for example would have more favorable terms for the supplier. The counter offer may optionally relate to the overall group bid and/or to one or more characteristics of the group of users (for example, optionally the supplier could accept only users having an address for receiving a physical product within a certain geographical area). The group of users may also optionally be split due to differences in desired characteristics of the item by a plurality of different portions of the group of users. The group of users may also optionally be split due to geographical characteristics as previously described (location but also optionally for reasons relating to tax and so forth) and/or simply because the number of users is too large for a particular supplier. Various combinations of these reasons may also optionally be implemented.

In stage 7, the item is purchased by a successful group of users with accepted bids according to the group average bid.

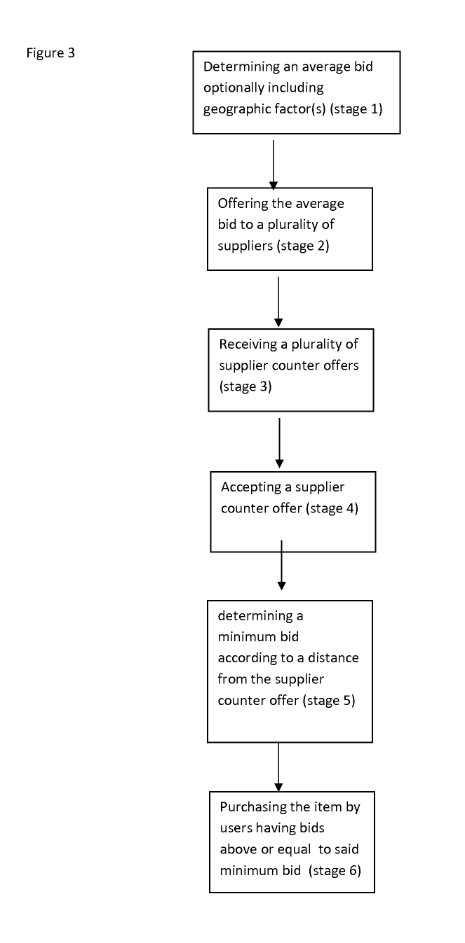

FIG. 3 is a flowchart of an exemplary, illustrative method according to at least some embodiments of the present invention for an exemplary bidding process with regard to the supplier(s). As shown, in stage 1 an average group bid is determined, optionally including one or more geographical factors as previously described. In stage 2, the average group bid is offered to a plurality of suppliers. In stage 3, optionally a plurality of supplier counter offers is received. Such counter offers may optionally relate to cost and/or to one or more non-cost parameters, for example relating to the quality of goods, speed of delivery and so forth.

In stage 4, a supplier counter offer is optionally accepted, for example because it is closest to the average group bid and/or has one or more other desirable characteristics. In stage 5, a minimum bid for the group is preferably set according to a distance from the supplier counter offer, as previously described. In stage 6, users whose bids are equal to or above the minimum are informed that their bids were successful and the purchasing process is performed.

FIG. 4 is a flowchart of an exemplary, illustrative method according to at least some embodiments of the present invention for analysis of historical bidding processes. As shown, in stage 1 a plurality of bidding processes is monitored. In stage 2, a plurality of overall group bids, such as group average bids, group median bids and so forth for a plurality of categories is analyzed from the monitored bidding processes. The categories may optionally relate to categories of different types of products, products as opposed to services, physical as opposed to virtual items, and so forth.

In stage 3, a statistical basis for successful group bids by category is determined according to analysis of the historical bids (for example, by determining a group average bid or a group median bid, or indeed any type of statistical analysis which forms a basis for determining a minimum bid). In stage 4, successful group bids and also a distance is determined according to the statistical basis, so that a minimum bid may optionally be calculated even before one or more suppliers are approached with overall group bids.

FIGS. 5A and 5B relate to flowcharts of exemplary, illustrative methods according to at least some embodiments of the present invention for an exemplary bidding process with regard to the users (FIG. 5A) or the supplier(s) (FIG. 5B).

As shown in FIG. 5A, in stage 1 the group bidding process is initiated, whether through opening a bidding group according to a request of one or more users, or according to a request of one or more suppliers; or according to an initiative of the central computational entity (if present); or a combination thereof.

In stage 2 a plurality of bids is received from a plurality of users; optionally only one bid is permitted per user, but the user may optionally be permitted to change his/her bid as long as bids are being accepted (for example and without limitation, to increase a likelihood of a bid being accepted), as shown with regard to stage 3. Optionally, the individual bids are made public but alternatively they are kept secret. Also optionally a user may put a ceiling or maximum price for the bid. In stage 4, an average group bid is calculated from the plurality of received bids (for example, preferably after the bidding process has been closed; optionally, one or more intermediate average group bids may be calculated in order to indicate to one or more users the likelihood of success of their bids.

In stage 5, this average group bid (preferably calculated after the bidding process has finished) is provided to one or more suppliers to indicate whether this bid is acceptable. If the supplier accepts the average group bid, or even provides a lower bid (for example in order to outbid another supplier) in stage 6, then the process jumps to stage 8. Otherwise, in stage 7, if the supplier counter offer is higher than the average group bid, the group is split into a plurality of portions and the average bid is recalculated for a portion having higher bids.

In stage 8, if the new average bid is at least equal to the supplier counter offer, users are informed of accepted bids (from the group having the higher bids). For the users with unsuccessful bids, in stage 9, users having non-accepted bids are invited, preferably individually, to raise their bids to at least the new average group bid. In stage 10, the clearing process is performed to handle the purchases by the successful users from stages 8 and 9. In stage 11, the successful users purchase the items.

FIG. 5B relates to an exemplary bidding process with regard to the supplier(s). As shown, in stage 1, at least one and preferably a plurality of suppliers receive average bid and group characteristics from the above process in FIG. 5A. In stage 2, if a supplier accepts average bid and hence the group, the method proceeds to the clearing process in stage 5.

Otherwise in stage 3, if a supplier rejects average bid and hence the group, and optionally if all suppliers reject the average group bid and hence the group, then the group is altered and the average is recalculated as previously described. In stage 4, if a supplier accepts new average bid and group, then the bids of the group are accepted and in stage 5, the clearing process is performed. In stage 6, the successful users purchase the products from the suppliers.

While the invention has been described with respect to a limited number of embodiments, it will be appreciated that many variations, modifications and other applications of the invention may be made.

What is claimed is:

1. A method for bidding and purchase for an item by a buying group, the group comprising a plurality of users communicating through a plurality of user computers, the method comprising: receiving a plurality of bids from the plurality of users through the plurality of user computers by a computational entity; calculating an overall group bid of said plurality of bids by said computational entity; selecting a plurality of successful user bids from said plurality of bids according to said overall group bid to form selected user bids; and for user bidding said selected user bids, purchasing the item by said purchasing users, such that there is a distribution of different payments by said purchasing users according to a distribution of different user bids within said selected user bids.

2. The method of claim 1, wherein said computational entity comprises a central server.

3. The method of claim 1, wherein said computational entity comprises the plurality of user computers and wherein said calculations are distributed over the plurality of user computers.

4. The method of claim 1, wherein said selecting a plurality of successful user bids comprises determining a minimum bid according to a distance from said overall group bid by said computational entity; wherein said selected user bids are above said minimum bid.

5. The method of claim 4, wherein said purchasing the item further comprises recalculating an overall group bid according to bids above said minimum bid; offering said overall group bid to at least one supplier; and accepting said overall group bid by an accepting supplier, such that said accepting supplier supplies the item to said purchasing users.

6. The method of claim 4, wherein said determining said minimum bid further comprises offering said overall group bid to at least one supplier; indicating an acceptable overall group bid by said at least one supplier; accepting a supplier offered overall group bid, wherein said minimum bid is calculated according to said supplier offered overall group bid.

7. The method of claim 4, wherein said determining said minimum bid further comprises offering said overall group bid to at least one supplier; receiving either acceptance of said overall group bid or a counter-offer from said at least one supplier; if said overall group bid is not accepted, accepting a qualifying counter-offer bid from a supplier or more, wherein said minimum bid is calculated according to said qualifying counter-offer bid.

8. The method of claim 1, further comprising, before said purchasing the item by said purchasing users, setting a time period during which user bids are accepted; rejecting user bids after said time period has expired; and requiring users having bids above said minimum bid to purchase the item after said time period has expired.

9. The method of claim 8, further comprising, while said time period has not expired, receiving a new bid from a user; and displaying to the user an indication of a likelihood of success of said new bid, according to a comparison of said new bid to said overall group bid.

10. The method of claim 1, wherein said determining said minimum bid according to said distance from said overall group bid further comprises analyzing bids from the users to determine a distance of each bid from said overall group bid; accepting bids above said overall group bid; and accepting a low bid below said overall group bid if said low bid is not lower than a predefined distance from said overall group bid.

11. The method of claim 10, wherein said distance is determined according to one or more standard deviations from said overall group bid.

12. The method of claim 11, further comprising analyzing a plurality of successful bidding and purchasing processes for a plurality of items to determine a likely successful distance from said overall group bid.

13. The method of claim 12, wherein said plurality of items fall into a single item category and wherein said analyzing is performing for a plurality of item categories.

14. The method of claim 13, further comprising, while said time period has not expired, receiving a new bid from a user; and displaying to the user an indication of a likelihood of success of said new bid, according to a comparison of said new bid to said overall group bid with said likely successful distance from said overall group bid.

15. The method of claim 1, the method further comprising, before said receiving said plurality of bids from the users, starting the group according to a request from a user.

16. The method of claim 15, wherein said request from said user is received through a user computer by indicating an item of interest for purchase by said user to said computational entity.

17. The method of claim 16, wherein said indicating said item of interest is performed by the user according to a software interface installed on said user computer.

18. The method of claim 17 wherein during a time period for accepting bids, said receiving said plurality of bids further comprises joining the group by said plurality of users.

19. The method of claim 18, wherein each of said plurality of bids includes a purchase price of the item and a geographical cost.

20. The method of claim 19, wherein said geographical cost is limited to a maximum percentage of said purchase price.

21. The method of claim 20, wherein each of said plurality of bids only includes a purchase price of the item and wherein a geographical cost is borne by said supplier.

22. The method of claim 21, wherein said geographical cost comprises one or more of a delivery cost and a tax cost.

23. The method of claim 22, wherein each of said supplier and said user pays for one of said delivery cost and said tax cost.

24. The method of claim 23, wherein the item comprises a product.

25. The method of claim 24, wherein the item comprises a service.

26. The method of claim 25, further comprising providing a social network for supporting communication between the users and said computational entity.

27. The method of claim 26, further comprising splitting the group into a plurality of buying groups according to one or more of a number of users in the group and an overall group bid of each of said plurality of buying groups.

28. The method of claim 27, wherein said splitting the group further comprises rejecting the overall group bid of the group by a supplier; providing a counter offer of an adjusted overall group bid by the supplier; calculating a division of the group according to said adjusted overall group bid to a portion of the group that is maintained and a portion of the group that is rejected.

29. The method of claim 28, further comprising offering a possibility of adjusting a bid by the one or more users in the portion of the rejected group.

30. The method of claim 29, wherein said adjusting said bid comprises increasing said bid by the one or more users in the portion of the rejected group to at least said adjusted overall group bid.

31. The method of claim 30, the method further comprising, before said receiving said plurality of bids from the users, starting the group according to a request from a supplier.

32. The method of claim 31, the method further comprising, before said receiving said plurality of bids from the users, receiving a request from a user and a request from a supplier; and matching said user and supplier by forming a buying group.

33. The method of claim 32, further comprising calculating said overall group bid according to a calculation selected from the group consisting of an average of the plurality of user bids and a median of the plurality of user bids.

34. A system for bidding and purchase for an item by a buying group, the group comprising a plurality of users, the system comprising a plurality of user computers for use by the plurality of users, each of said plurality of user computers comprising a user interface; a supplier computer being operated by a computer, said supplier computer having a supplier computer interface; and a computational entity for communicating with said plurality of user computers and for receiving a plurality of bids from the plurality of users through the plurality of user computers, calculating an overall group bid of said plurality of bids, and selecting a plurality of successful user bids from said plurality of bids according to said overall group bid to form selected user bids according to a response from said supplier; wherein said supplier cannot select individual bids from said overall group bid but instead accepts or rejects said buying group according to said overall group bid.

35. The system of claim 34, wherein said computational entity comprises a central server.

36. The system of claim 34, wherein said computational entity comprises the plurality of user computers and wherein said calculations are distributed over the plurality of user computers.
